(19) United States
(12) Patent Application Publication
(10) Pub. No.: US 2007/0299761 A1
(43) Pub. Date: Dec. 27, 2007

(54) Real Estate Investment Techniques

(76) Inventors: Landon Victor Butler, Jr., Washington, DC (US); Landon Headley Butler, Washington, DC (US); Peter J. Cinquegrani, Rockville, MD (US); David F. Freeman JR., McLean, VA (US)

Correspondence Address: ARNOLD & PORTER LLP;ATTN: IP DOCKETING DEPT., 555 TWELFTH STREET, N.W., WASHINGTON, DC, 20004-1206, US

(21) Appl. No.: 11/692,089

(22) Filed: Mar. 27, 2007

Related U.S. Application Data
(60) Provisional application No. 60/786,014, filed on Mar. 27, 2006.

(51) Int. Cl. G06Q 40/00

(52) U.S. Cl. 705/36 T

(57) ABSTRACT

The present invention relates to real estate investment techniques for facilitating foreign investment in domestic real estate assets.

### CROSS-REFERENCE TO RELATED APPLICATIONS

This application claims the benefit of U.S. Provisional Application No. 60/786,014, filed Mar. 27, 2006, which application is herewith incorporated by reference in its entirety.

### FIELD OF THE INVENTION

The present invention relates to real estate investments. In particular, the present invention relates to real estate investment techniques for facilitating foreign investment in domestic real estate assets.

### RELATED ART

Common trust funds and collective investment funds are maintained by banks and trust companies for investment by pension, employee benefit or other trust and fiduciary customers. Many such funds invest directly or indirectly in real estate assets. These funds can qualify for federal income tax purposes as common trust funds under Section 584 of the Internal Revenue Code or group pension funds under Revenue Ruling 81-100 1981-1 C.B, 326; however, such qualifications are not favorable to foreign based investors that seek to take advantage of U.S. real estate investment opportunities. What is needed are real estate investment techniques which provide favorable tax treatment to foreign investors who are looking to invest in domestic real estate assets.

### BRIEF DESCRIPTION OF THE DRAWINGS

FIGS. 1-4 are diagrams of entities interacting in a manner to implement embodiments of the present invention

### DETAILED DESCRIPTION OF EMBODIMENTS OF THE PRESENT INVENTION

The present invention relates to real estate investment techniques that facilitate investment in domestic real estate assets by foreign investors. In accordance with one embodiment of the invention, a collective investment fund (“CIF”) (a type of fiduciary pooled investment fund maintained by a bank or trust company solely for pension and employee benefit plan investors) is provided that invests in real estate, and that qualifies and elects to be taxed as a “real estate investment trust” or “REIT” for federal income tax purposes. For purposes of federal banking and securities laws, the CIF would be a collective investment fund; but for federal income tax purposes it would be a REIT. This CIF/REIT could invest either directly in real estate, or in one or more other CIFs that invest in real estate, in other REITs, in real estate investment partnerships, or in a combination of the foregoing.

Collective investment funds normally elect treatment as either a “common trust fund” under Section 584 of the Internal Revenue Code, or as a group pension trust meeting the requirements of Revenue Ruling 81-100 1981-1 C.B. 326. Section 584 of the Internal Revenue Code provides tax pass-through treatment for common trust funds and collective investment funds maintained by banks and trust companies in accordance with Section 9.18 of the rules of the Office of the Comptroller of the Currency, 12 C.F.R. § 9.18. Group pension trusts meeting the requirements of Revenue Ruling 81-100 are exempt from tax. CIFs have been established and operated for many years to invest in real estate. However, those CIFs have operated for tax purposes as common trust funds under Section 584 of the Internal Revenue Code or as group pension trusts under Revenue Ruling 81-100 (or predecessor provisions and rulings). In contrast, the present invention does not meet the requirements under Revenue Ruling 81-100, and was structured specifically so as to not qualify under Section 584 of the Internal Revenue Code. Instead, the present invention involves the use of CIF's that meet the requirements applicable to, and that elect to be treated as domestically-controlled REITs for federal income tax purposes.

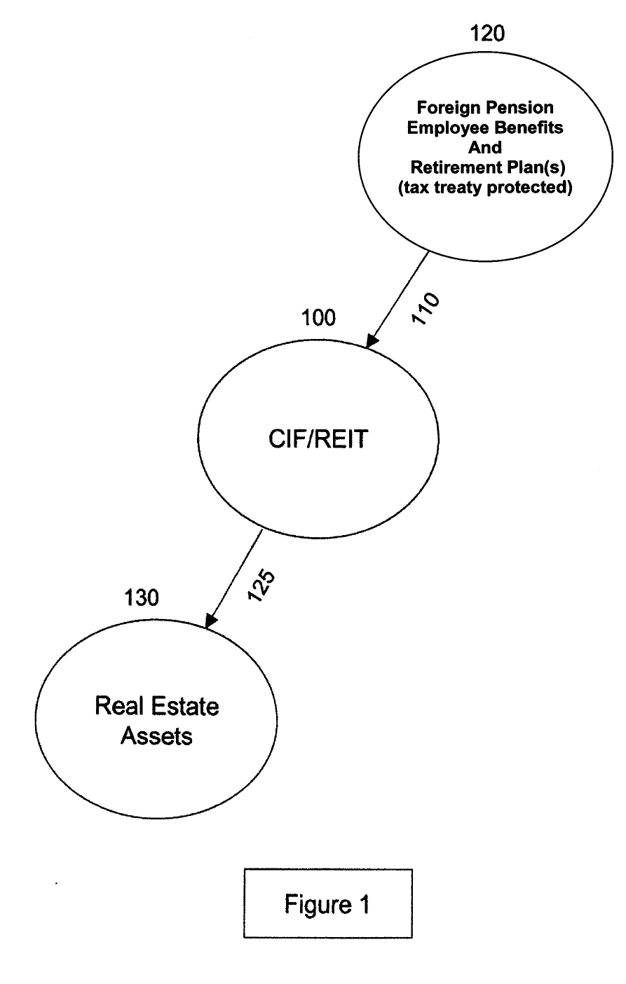

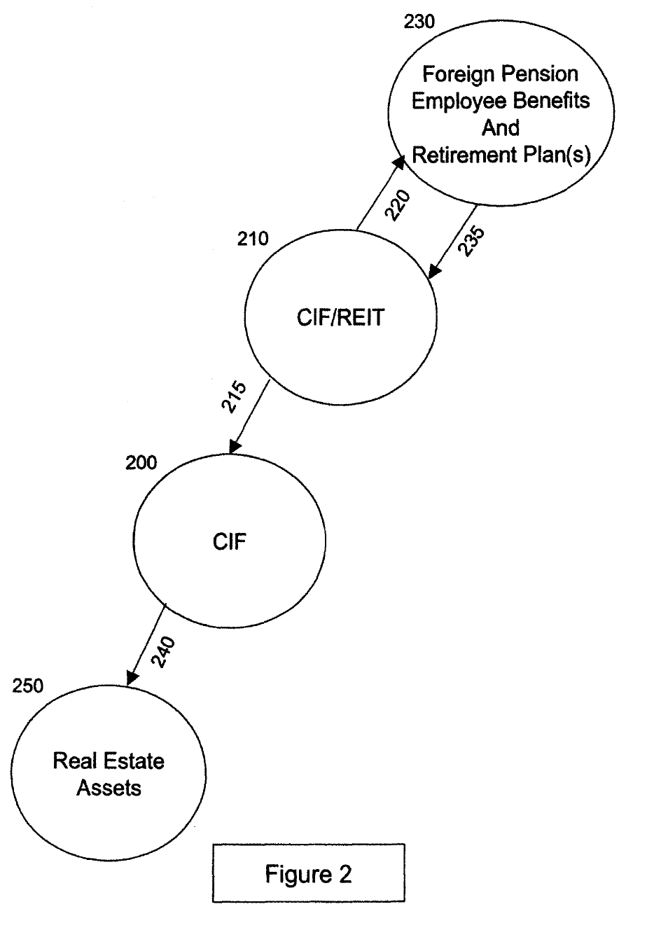

A characteristic to a REIT that is established and operated as a CIF (e.g., the CIF/REITs 100 and 210 of FIGS. 1 and 2, respectively) is that it would qualify for exemptions under the federal securities laws from registration under the Investment Company Act, 15 U.S.C. § 80a (by virtue of Section 3(c)(I1) of that Act), from registration of its securities under the Securities Act of 1933, 15 U.S.C. § 77 (by virtue of Section 3(a)(2) of that Act), and from registration of its securities and related public filings under the Securities Exchange Act of 1934, 15 U.S.C. § 78 (by virtue of Section 3(a)(12)(A)(v) of that Act).

A benefit to qualifying the CIF as a domestically-controlled REIT for federal income tax purposes, together with the reduced withholding taxes on ordinary dividends from a REIT under applicable tax treaties, is to qualify the income from the REIT and gains from the sale of shares in the REIT for more favorable federal tax treatment for Canadian or other non-U.S. pension and employee benefit plans that are investors in the CIF. Under the Foreign Investors Real Property Tax Act of 1984 (“FIRPTA”) and U.S. income tax rules, foreign investors (including foreign pension plans) pay a significant tax on income and gains on investments in U.S. real estate. FIRPTA provides more favorable treatment for real estate investments made by non-U.S. investors if the real estate investment is held through an entity that is qualified as a domestically-controlled REIT for federal income tax purposes. Section 897(h) of the Internal Revenue Code.

As shown in FIG. 1, the present invention enables a bank or trust company (not shown) to form a CIF/REIT 100 that would receive 110 investments from foreign pension, employee benefits and retirement plan(s) 120, including Canadian and other non-U.S. plans (together with U.S. pension plans, not shown). The CIF/REIT 100, would, in turn, invest 125 directly or indirectly in U.S. real estate asset(s) 130 (including, for example, real estate properties and mortgages), and that, unlike current tax qualification structures in use by CIFs, would have tax characteristics attractive to pension, employee benefits and retirement plan(s) 120, such as non-U.S. pension plans.

The present invention also encompasses a system of accounting, bookkeeping, and computer software, that would track and account for, and make proper allocations in respect of, the investments of the CIF/REIT directly in real estate, or indirectly through one or more other CIFs, REITs, or real estate partnerships, for tax accounting, reporting and compliance purposes, pension accounting, reporting and compliance purposes, regulatory accounting and compliance purposes, and general accounting purposes.

FIG. 2 shows the use of another embodiment of the present invention, in which a bank or trust company with an existing, well-diversified CIF 200, forms a new CIF/REIT 210 that would invest 215 in units of the existing CIF 200 and issue 220 its units to foreign pension, employee benefits and retirement plan(s) 230, including Canadian and other non-U.S. plans (together with U.S. pension plans, not shown). Provided the existing CIF does not meet the requirements of Section 584, it will be structured to be treated as either a corporation which would elect to be taxed as a REIT or as a partnership for federal income tax purposes. Each such status will allow the existing CIF to avoid tax. The use of the present invention would thus allow foreign pension, employee benefits and retirement plan(s) 230 to invest 235 in the existing CIF 200 via the CIF/REIT 210 and avoid the FIRPTA tax on the sale of the shares of the domestically-controlled REIT and reduce the U.S. tax on the ordinary dividends from the REIT to the extent of reduced withholding taxes under applicable tax treaties. The CIF 200 would, in turn, invest 240 in U.S. real estate asset(s) 250.

The present invention also encompasses a CTF (a type of fiduciary pooled investment fund maintained by a bank or trust company for trust, estate and other fiduciary accounts) that invests in real estate and that does not qualify for special tax treatment under Section 584 of the Internal Revenue Code, but instead, meets the requirements applicable to, and elects to be treated as a REIT for federal income tax purposes. For purposes of federal banking and securities laws, the CTF would be a common trust fund; but for federal income tax purposes it would be a REIT. This CTF/REIT could invest either directly in real estate, or in one or more other CTFs that invest in real estate, in other REITs, in real estate investment partnerships, or in a combination of the foregoing.

The present invention also encompasses a system of accounting, bookkeeping, and computer software, that would track and account for, and make proper allocations in respect of, the investments of the CTF/REIT directly in real estate, or indirectly through one or more other CTFs, REITs, or real estate partnerships, for tax accounting, reporting and compliance purposes, trust accounting, compliance and reporting purposes, regulatory accounting compliance purposes, and general accounting purposes.

A benefit to qualifying the CTF as a domestically-controlled REIT for federal income tax purposes, together with the reduced withholding on ordinary dividends from a REIT under applicable tax treaties, is to qualify the income from the REIT and gains from the sale of the shares in the REIT for more favorable federal tax treatment for Canadian or other non-U.S. trust and fiduciary accounts of the bank or trust company (or of its affiliated banks and trust companies) that are investors in the CTF. Under FIRPTA and U.S. income tax rules, foreign investors (including foreign-owned trusts and fiduciary accounts) pay a significant tax on income and gains on investments in U.S. real estate. FIRPTA provides more favorable treatment for real estate investments made by non-U.S. investors if the real estate investment is held through an entity that is qualified as a domestically-controlled REIT for federal income tax purposes.

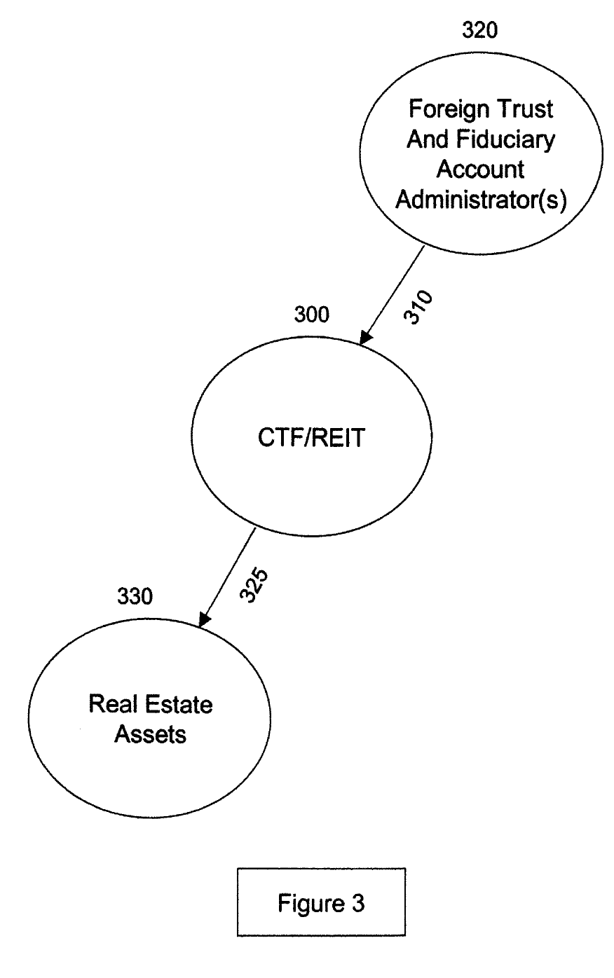

As shown in FIG. 3, the present invention enables a bank or trust company to form a CTF/REIT 300 that would be tax-efficient for investments of trust and other fiduciary accounts at the bank or trust company (or at its affiliated banks or trust company) that are beneficially owned 310 by foreign trust and fiduciary account administrator(s) 320, including banks or trust companies administering trusts having Canadian and other non-U.S. beneficial owners (together with U.S. accounts, not shown). The CTF/REIT 300 would, in turn, invest 325 directly or indirectly in U.S. real estate assets 330, and would, unlike current tax qualification structures in use by CTFs, have tax characteristics attractive to trusts and other fiduciary accounts with non-U.S. beneficial owners.

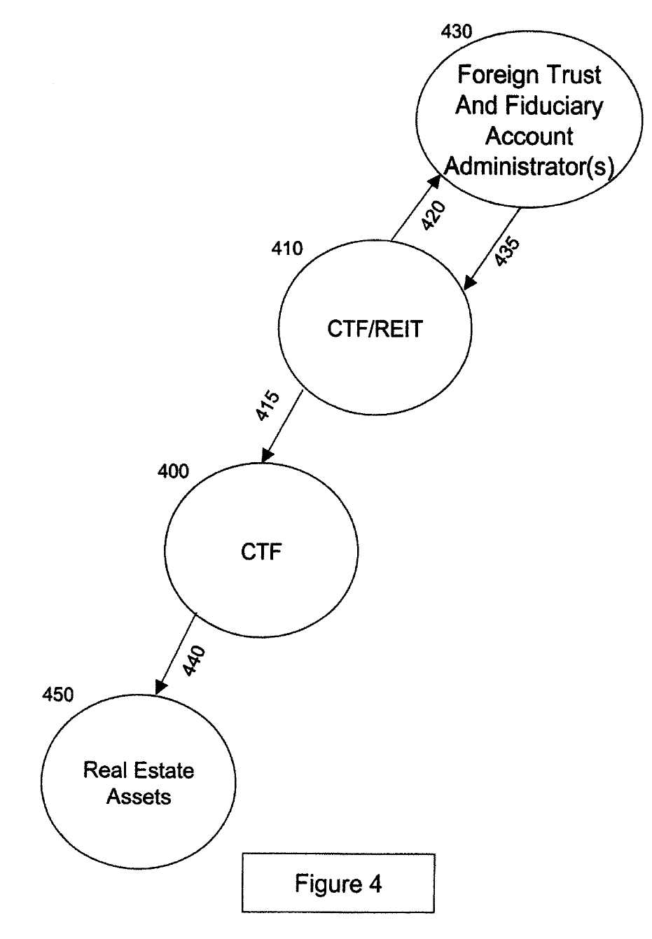

FIG. 4 shows the use of yet another embodiment of the present invention, in which a bank or trust company with an existing, well-diversified real estate CTF 400, forms a new CTF/REIT 410 that would invest 415 in units of the existing CTF 400 and issue 420 its units to foreign trust and fiduciary account administrator(s) 430, including banks or trust companies administering trusts having Canadian and other non-U.S. beneficial owners (together with U.S. accounts, not shown). The use of the present invention would thus allow foreign trust and fiduciary account administrator(s) 430 to invest 435 in the existing CTF 400 via the CTF/REIT 410 and avoid the FIRPTA tax on the sale of the shares of the domestically-controlled REIT and reduce the U.S. tax on the ordinary dividends from the REIT to the extent of reduced withholding taxes under applicable tax treaties. The CTF 400 would, in turn, invest 440 in U.S. real estate assets 450.

A characteristic to a REIT that is established and operated as a CTF (e.g., the CTF/REIT 300 and 410) is that it would qualify for exemptions under the federal securities laws from registration under the Investment Company Act, 15 U.S.C. § 80a (by virtue of Section 3(c)(3) of that Act), from registration of its securities under the Securities Act of 1933, 15 U.S.C. § 77 (by virtue of Section 3(a)(2) of that Act), and from registration of its securities and related public filings under the Securities Exchange Act of 1934, 15 U.S.C. § 78 (by virtue of Section 3(a)(12)(A)(iii) of that Act) or it would otherwise qualify under some other exemptions.

Although different embodiments of the present invention have been discussed, those skilled in the art will appreciate that variations may be made thereto without departing from the principles of the present invention. Although the preferred embodiment has been described to include a number of features, an apparatus, method and computer readable medium may be designed which does not include all of those features, and yet still fall within the spirit and scope of the present invention.

We claim:

1. A method of facilitating foreign investment in domestic real estate assets, the method comprising:
forming a collective investment fund that receives investments from foreign entities and that invests in one or more domestic real estate assets, said collective investment fund electing to be taxed as a real estate investment trust for tax purposes.

2. The method defined by claim 1, wherein said foreign entities include one or more foreign pensions.

3. The method defined by claim 1, wherein said foreign entities include one or more foreign employee benefits plans.

4. The method defined by claim 1, wherein said foreign entities include one or more foreign retirement plans.

5. The method defined by claim 1, wherein said domestic real estate assets include one or more real estate properties.

6. The method defined by claim 1, wherein said domestic real estate assets include one or more mortgages.

7. The method defined by claim 1, wherein said collective investment fund is maintained by a bank.

8. The method defined by claim 1, wherein said collective investment fund is maintained by a trust company.

9. The method defined by claim 1, wherein said collective investment fund does not qualify as a common trust fund under Section 584 of the Internal Revenue Code.

10. A method of facilitating foreign investment in domestic real estate assets, the method comprising:
forming a first collective investment fund that receives investments from foreign entities and that invests indirectly in one or more domestic real estate assets, the collective investment fund qualifying and electing to be taxed as a real estate investment trust for tax purposes.

11. The method defined by claim 10, wherein said first collective investment fund invests in an investment vehicle that, in turn, invests in said domestic real estate assets.

12. The method defined by claim 11, wherein said investment vehicle existed at a time prior to the forming of said first collective investment fund.

13. The method defined by claim 1 1, wherein said foreign entities include one or more foreign pensions.

14. The method defined by claim 11, wherein said foreign entities include on or more foreign employee benefits plans.

15. The method defined by claim 11, wherein said foreign entities include one or more foreign retirement plans.

16. The method defined by claim 11, wherein said domestic real estate assets include one or more real estate properties.

17. The method defined by claim 1 1, wherein said domestic real estate assets include one or more mortgages.

18. The method defined by claim 11, wherein said first collective investment fund is maintained by a bank.

19. The method defined by claim 1 1, wherein said first collective investment fund is maintained by a trust company.

20. The method defined by claim 11, wherein said first collective investment fund does not qualify as a common trust fund under Section 584 of the Internal Revenue Code.

21. The method defined by claim 11, wherein said investment vehicle is a second collective investment fund.

22. The method defined by claim 11, wherein said investment vehicle is a real estate investment trust.

23. The method defined by claim 1 1, wherein said investment vehicle is a real estate partnership.
